(19) United States
(12) Patent Application Publication
(10) Pub. No.: US 2002/0113989 A1
(43) Pub. Date: Aug. 22, 2002

(54) Methods and systems for print-processor modified printing

(76) Inventors: Andrew Rodney Ferlitsch, Tigard, OR (US); James E. Owen, Vancouver, WA (US)

Correspondence Address: SHARP LABORATORIES OF AMERICA, 5750 NW PACIFIC RIM BLVD, CAMAS, WA, 98607, US

(21) Appl. No.: 09/681,208

(22) Filed: Feb. 22, 2001

Related U.S. Application Data
(60) Provisional application No. 60/261,132, filed on Jan. 11, 2001.

(51) Int. Cl. G06F 15/00; G06F 13/00; G06F 3/12; G06K 15/02

(52) U.S. Cl. 358/1.15; 709/201

(57) ABSTRACT

Embodiments of the present invention comprise methods and systems which enable a user to distribute print tasks to a plurality of printing devices without the use of additional hardware for this purpose. These systems and methods are typically used in conjunction with a computer network comprising at least one computing device and a plurality of printing devices. Printing tasks which are typically sent to a single printing device may be distributed to multiple printing devices to increase printing speed, volume and/or capacity. This distribution capability can be achieved without the use of additional hardware and firmware and without modification to software applications.

### CROSS REFERENCE TO RELATED APPLICATIONS

This application claims the benefit of Provisional Application Serial No. 60/261,132, entitled “Methods and Systems for Print-Processor Modified Printing” filed Jan. 11, 2001 by inventors Ferlitsch et al.

### BACKGROUND OF INVENTION

Embodiments of the present invention relate to methods and systems for distributing a print task to multiple printers in a network. This process may be described as network cluster printing. More particularly, these embodiments relate to methods and systems for enabling network cluster printing through the use of novel software applications. These embodiments allow network cluster printing without the use of additional hardware and allow the use of printers that are otherwise incapable of cluster printing.

Many offices can generate a high volume of printer output or require high print rates to meet deadlines. When these needs are fairly constant, large, high-production printers and associated hardware may be required. These high-production units are expensive to procure and maintain and, generally, are only made economically feasible by a constant high demand for printer output. When printer requirements fluctuate, the costs of these high-production printers are difficult to justify. However, when sporadic, high printer throughput is a necessity, some offices are forced to bear the costs of expensive printer equipment that runs at well below its capacity most of the time.

Cluster printing has been introduced to avoid this problem. Cluster printing involves the use of multiple printers in a network. With cluster printing, print jobs can be sent to a multiple printer network with a capacity that rivals the capacity of expensive, high-throughput equipment. Generally, this network is comprised of multiple lower-production printers that may already exist in an office environment making the cost of the network very manageable.

Through the use of cluster printing, a user may choose to split a single print job among several printers to increase print job speed and decrease print time. Print jobs that include multiple copies may be divided so that each printer in a network prints some of the copies. Other variations of print job distribution may also be implemented.

Cluster printing may be implemented through specialized printers which contain cluster-enabling firmware. When these printers are interconnected via cables, they can share printing jobs. In some cases, the marking engines are connected to enable division of printing tasks between the connected printers.

Other methods of implementing cluster printing functions require the use of additional hardware. Typically, a specialized print server is used. This server is generally a high-performance general purpose computer to which print jobs are directed by the network. Specialized software on the server allows print jobs or copies thereof to be distributed among multiple printers that are managed by the server.

These known cluster printing implementations require specialized printer or server hardware or software to provide cluster printing functions.

### SUMMARY OF INVENTION

Embodiments of the present invention comprise methods and systems which enable a user to distribute print tasks to a plurality of printing devices without the use of additional hardware or server software for this purpose. These systems and methods are typically used in conjunction with a computer network comprising at least one computing device and a plurality of printing devices. Printing tasks which are typically sent to a single printing device may be distributed to multiple printing devices to increase printing speed, volume and/or capacity. This distribution capability can be achieved without the use of additional hardware and firmware and without modification to software applications.

### BRIEF DESCRIPTION OF DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram showing an embodiment of the present invention comprising a modifying print processor;

FIG. 2 is a diagram showing an embodiment of the present invention comprising a modifying print processor performing a cluster printing task;

FIG. 3 is a diagram showing an embodiment of the present invention comprising a system for cluster printing of a printer-ready file;

FIG. 4 is a diagram showing an embodiment of the present invention comprising a system for cluster printing of journalled printer data;

FIG. 5 is a diagram showing an embodiment of the present invention comprising a driver-based cluster printing user interface and EMF mode output wherein copy-splitting is performed;

FIG. 6 is a diagram showing an embodiment of the present invention comprising a driver-based cluster printing user interface and RAW mode output wherein copy-splitting is performed;

FIG. 7 is a diagram showing an embodiment of the present invention comprising a driver-based cluster printing user interface and EMF mode output wherein job-splitting is performed;

FIG. 8 is a diagram showing an embodiment of the present invention comprising a driver-based cluster printing user interface and RAW mode output wherein job-splitting is performed;

FIG. 9 is a diagram showing an embodiment of the present invention comprising a print-processor-based cluster printing user interface and EMF mode output wherein copy-splitting is performed;

FIG. 10 is a diagram showing an embodiment of the present invention comprising a print-processor-based cluster printing user interface and RAW mode output wherein copy-splitting is performed;

FIG. 11 is a diagram showing an embodiment of the present invention comprising a print-processor-based cluster printing user interface and EMF mode output wherein job-splitting is performed; and

FIG. 12 is a diagram showing an embodiment of the present invention comprising a print-processor-based cluster printing user interface and RAW mode output wherein job-splitting is performed.

### DETAILED DESCRIPTION

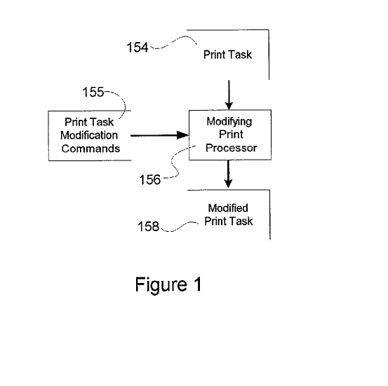

The figures listed above are expressly incorporated as part of this detailed description. It will be readily understood that the components of the present invention, as generally described and illustrated in the figures herein, could be arranged and designed in a wide variety of different configurations. Thus, the following more detailed description of the embodiments of the systems and methods of the present invention, as represented in FIGS. 1 through 12 is not intended to limit the scope of the invention, as claimed, but it is merely representative of the presently preferred embodiments of the invention. The currently preferred embodiments of the present invention will be best understood by reference to the drawings, wherein like parts are designated by like numerals throughout.

The definitions in this and subsequent paragraphs apply throughout this specification and related claims. The term “print job” may refer to any combination of data that can be printed. A print job may comprise text and/or graphics and may comprise part of a page, a single page or many pages. Generally, a print job is generated by an application, such as a word processor, spread sheet, etc., however, a print job may also comprise a file or data in memory that may be sent directly to a print process.

The term “print copy” or “copy” may refer to data, code or commands which generate a single printing device output of a print job or may refer to the actual hard copy output of the print job.

The term “print task” may comprise any combination of print jobs and copies thereof. A print task may comprise one or more print jobs and one or more copies of each print job.

The term “copy splitting” may refer to a process by which a print task comprising multiple copies is divided into multiple modified print tasks with each modified print task comprising a portion of the total number of copies.

The term “job splitting” may refer to a process by which a print task comprising at least one print job is split into multiple modified print tasks with each modified print task comprising a portion of a print job.

References to a Microsoft Windows® or Windows® operating system refer to any version or variation of a Microsoft Windows® operating system comprising Windows 95®, Windows 98®, Windows NT®, Windows 2000®, Windows ME®, Windows XP® and others. While exemplary embodiments of the present invention may be directed to a Windows® operating system and environment, systems and methods directed to other operating systems such as Macintosh®, UNIX, DOS, Linux and others are to be contemplated within the scope of the present invention.

Embodiments of the present invention may be used to achieve print task modification, copy splitting, job splitting and various combinations of these concepts along with related distribution tasks that allow modified print tasks to be distributed to multiple printing devices. In some embodiments, a print task comprising multiple page jobs and multiple copies of each job may be split into multiple modified print tasks with each modified print task comprising a portion of the copies of a portion of the pages thereby accomplishing simultaneous job splitting and copy splitting.

In some embodiments, a print task 162 comprising multiple pages may be split into multiple print tasks 164 each comprising a portion of the pages in the original print job. Some embodiments may modify a print task 162 which comprises multiple copies of a print job by creating multiple modified print tasks 164 each task comprising one or more of the copies in the original print task 162. In other embodiments, the print task may comprise multiple pages and multiple copies of the pages wherein the task is split into multiple modified tasks each comprising a portion of the copies and/or a portion of the pages. These modified print tasks 164 may be directed to multiple printing devices to speed job output, increase overall print capacity, improve destination availability or other reasons.

Some embodiments of the present invention may comprise print system components that may be added to existing print systems or built into new systems. These embodiments, shown in FIG. 1, may comprise a modifying print processor MPP 160 that is capable of receiving a print task 154 and modifying the print task 154 to change its format, destination, quantity or any other attribute. Modification parameters may be received as print task modification commands 155 from a user, a system administrator or some other source. MPP 156 may be interactive and query or prompt a user for additional input based on prior input or print task data. Once modifications have been made by MPP 156, one or more modified print tasks 158 are output to the original destination or a modified destination.

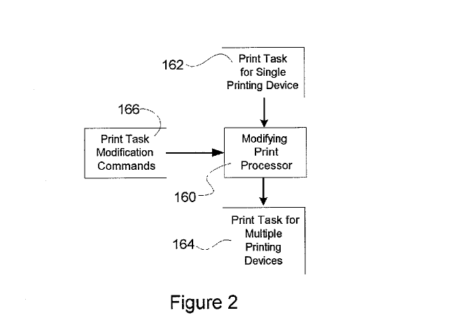

A specific form of MPP 156, as shown in FIG. 2, is a cluster-enabled print processor (CPP) 160. CPP 160 receives a print task 162 that is configured for printing on a single printing device. Based on print task modification commands 166, CPP 160 may modify print task 162 so that it may be printed on multiple printing devices. CPP 160 may modify print task 162 by splitting print task 162 into multiple modified print tasks and directing these print tasks to different destinations or printing devices. In some embodiments, a print task 162 comprising multiple pages may be split into multiple print tasks 164 each comprising a portion of the pages in the original print job. Some embodiments may modify a print task 162 which comprises multiple copies of a print job by creating multiple modified print tasks 164 each task comprising one or more of the copies in the original print task 162. In other embodiments, the print task may comprise multiple pages and multiple copies of the pages wherein the task is split into multiple modified tasks each comprising a portion of the copies and/or a portion of the pages. These modified print tasks 164 may be directed to multiple printing devices to speed job output, increase overall print capacity, improve destination availability or other reasons.

Print task modification commands 155 and 166 may be obtained through the use of a user interface such as a dialog box. The interface may be displayed at the time of printing to obtain user preferences or it may be displayed at some other time and the preferences may be stored for use at the time of printing. This interface may be a print-processor-based user interface, a driver-based user interface, an independent user interface or some other entity which prompts for user input and sends the resulting data to a print processor such as an MPP 156 or CPP 160.

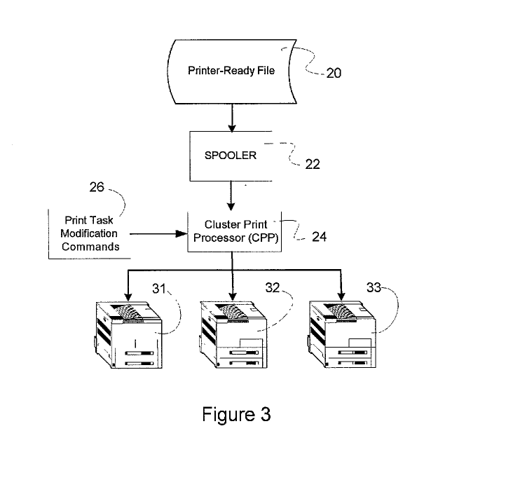

Some embodiments of the present invention may be described with reference to FIG. 3. In these embodiments, a printer-ready print task file 20, such as a RAW, PCL, Postscript, TIFF or PDF file, is sent to a spooler 22. Spooler 22 subsequently sends print task file 20 to a cluster-enabled print processor (CPP) 24. CPP 24 also receives print task modification commands 26 which may be specified by a user in a variety of ways. Print task modification commands 26 may be gathered through the use of a dialog box or other form of user prompt which may be generated directly from CPP 24, from a driver, a configuration file or some other source. Some of these print task modification command sources are explained in detail below. Print task modification commands 26 may be prompted for or otherwise generated when a print task file 20 is sent or at some other time prior to printing. When printer distribution is often constant, a static print task modification command configuration file may be maintained for multiple uses.

CPP 24 may modify a print task file 20 as it is received from spooler 22 according to the print task modification commands 26. Generally, commands 26 comprise distribution data for distributing a print task among multiple printing devices. When files exist in a RAW file format or a similar printer-ready format, they may be sent directly from CPP 24 to available printers 31, 32 and 33 for cluster printing according to print task modification commands 26.

Typically, a print task file 20 will comprise data describing text and/or graphics to be printed as well as data describing formatting, print job characteristics, copy quantity and other information. A print task may comprise one or more copies of a print job and a print job may comprise print data from one or more files, applications or sources. However, most typically, a print task will comprise one or more copies of a print job from a single application. A print task may be expressed in a file format as a print task file such as a Microsoft Windows Enhanced Metafile (EMF) file, a RAW file or some other printer compatible format.

A print task may be modified in many ways, however, most commonly, a print task is divided or split into copies or portions of a print job. When a print task comprises multiple copies, the copies may be distributed among multiple printers. For example and not by way of limitation, if six copies are desired and three printers are selected and available, two copies of the print job may be distributed to each of the available printers. As a further non-limiting example, when only one copy of a multiple-page document print job is desired, the document may be split into portions of a document with each portion distributed to a different printer. A three hundred page print job may be distributed by sending the first hundred pages to a first printer, the second hundred pages to a second printer and the third hundred pages to a third printer.

Print tasks may be divided or split by copies, job portions or other divisions. These divisions may then be distributed to available printers according to printer speed, capacity, availability, available capacity or other attributes. When the selected printing devices have similar characteristics, the task may be divided evenly among them. When one or more printing devices has characteristics different from the others, the print load may be distributed according to printing device capacity, speed, availability, available capacity or some other characteristic.

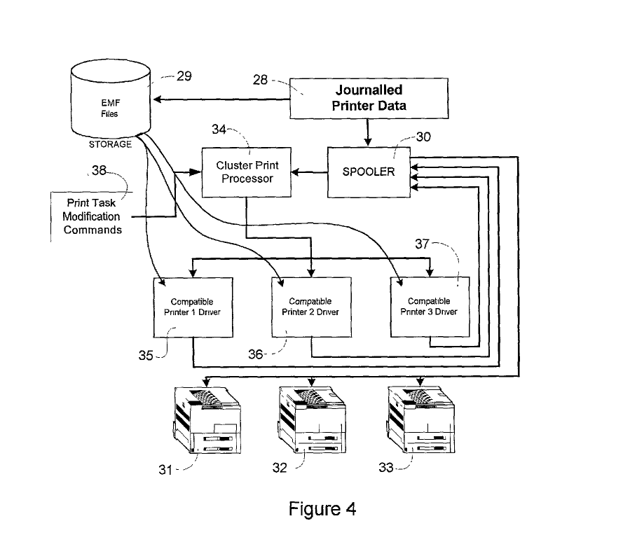

Some embodiments of the present invention are adapted to be use with journalled print tasks as shown in FIG. 4. Journalled printer data 28, which may comprise EMF data, is sent to a spooler 30 for streaming to a cluster-enhanced print processor (CPP) 34. CPP 34 may also receive print task modification commands 38 which describe cluster printing parameters. Print task modification commands 38 may be gathered through the use of a dialog box or other form of user prompt which may be generated directly from CPP 34, from a driver, a configuration file or some other source.

CPP 34 may modify a print task in many ways as described, in part, above. A modified print task which is some portion of the original print task is created for each of the selected printers. These modified print tasks are sent to printer drivers 35, 36 or 37 for each of the printers selected for the task. When EMF data is used by the system, the drivers 35, 36 and 37 may read EMF files from a storage device 29 as needed. These EMF files are combined with modified print task data and sent to spooler 30 for distribution to each printer 31, 32 and 33. It should be noted that spooler 30 used for the modified print task may be the same spooler 30 used for the journalled print data 28 or may be a different system which may be present in the printers 31, 32 and 33 themselves.

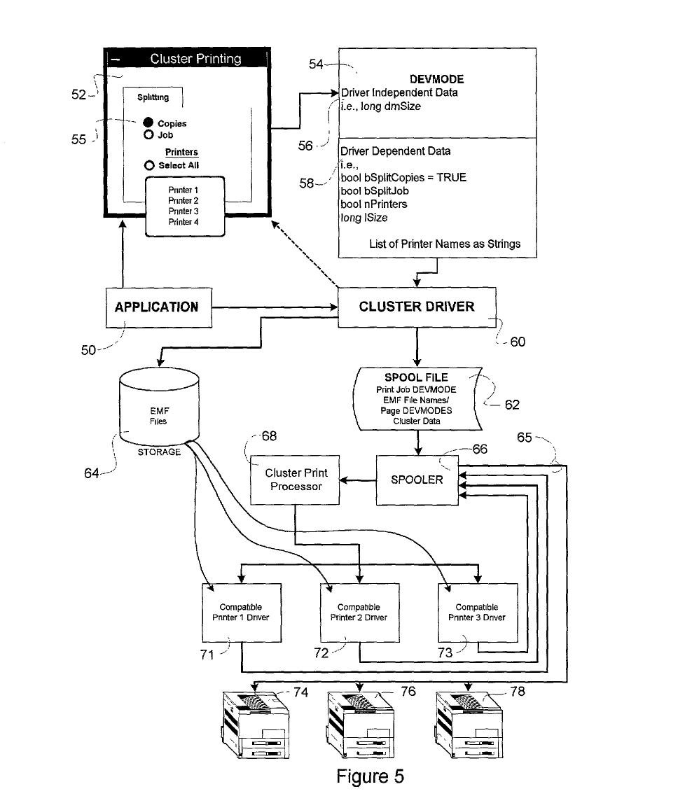

Some embodiments of the present invention may be adapted for use with applications which utilize an Enhanced Meta File (EMF) printer file format and some of these embodiments may utilize a driver-based user interface to collect print task modification commands. An example of these embodiments may be described with reference to FIG. 5 which shows a user application 50 which may be used to create a print task. Application 50 may be a word processor, spreadsheet, database, graphics program or some other application or combination of applications. When a user is ready to print from the application 50, the user typically selects a print option from a menu structure which activates a print driver dialog box allowing the user to select from several print options. This action may also invoke a cluster printing dialog box 52 which allows a user to select from several print task modification options. In some embodiments, cluster printing dialog box 52 may allow a user to select copy splitting and job splitting options as well as multiple printer selection. Other selections may also be available. In this exemplary embodiment, copy splitting is selected to illustrate this function. It should be noted that these selections may be made in advance and default options may be selected to avoid repeated operations each time printing is performed.

Once a user has made print dialog selections and cluster printing selections, device initialization and environment data 54 is sent to the cluster driver 60. In a Microsoft Windows operating system environment, device initialization and environment data 54 may be devmode data. Device initialization and environment data 54 may comprise driver independent data 56 and driver dependent data 58 as well as other data. Cluster driver 60 may also receive data directly from application 50 which may comprise print task data.

Cluster driver 60 takes device initialization and environment data 54 and data from application 50 and creates a spool file 62 which may comprise print job data, EMF file identification data, page data, print task distribution data and other information. In systems which employ EMF files, Cluster driver 60 may also write EMF files 64 to storage for later access. Spool file 62 is sent to spooler 66 to continue the modified printing process. Spooler 66 performs typical spooler functions known in the art and sends print data to cluster print processor (CPP) 68.

CPP 68 takes data from spooler 66 and configures the print data for distribution to multiple printing devices when selected. CPP 68 may modify the print task to achieve copy splitting, job splitting or other functions which distribute a print task among multiple printers. CPP 68 may split a task into multiple modified print tasks which are sent to the multiple compatible printer drivers 71, 72 or 73. In this embodiment, part of the data sent to printer drivers 71, 72 and 73 identifies the EMF files which correspond to a specific modified print task sent to an individual printer. With this data printer drivers 71, 72 and 73 may read the appropriate EMF files from storage 64 to complete a modified print task. In this example which illustrates a copy splitting function, copies of a print job are distributed among the selected printers. Generally, when printers have similar capacity and availability, an equal number of copies will be sent to each selected printer. However, when printer capabilities vary, more copies may be sent to one printer than another. Once a driver has all the data for a modified print task, the task is forwarded to a spooler 66 for spooling to a corresponding printer 74, 76 or 78. Typically, a modified print task comprising a portion of the original print task is sent to each selected printer 74, 76 and 78. In the case of copy splitting, the same print job is sent to each of the selected printers 74, 76 and 78 and each printer is directed to print a number of copies.

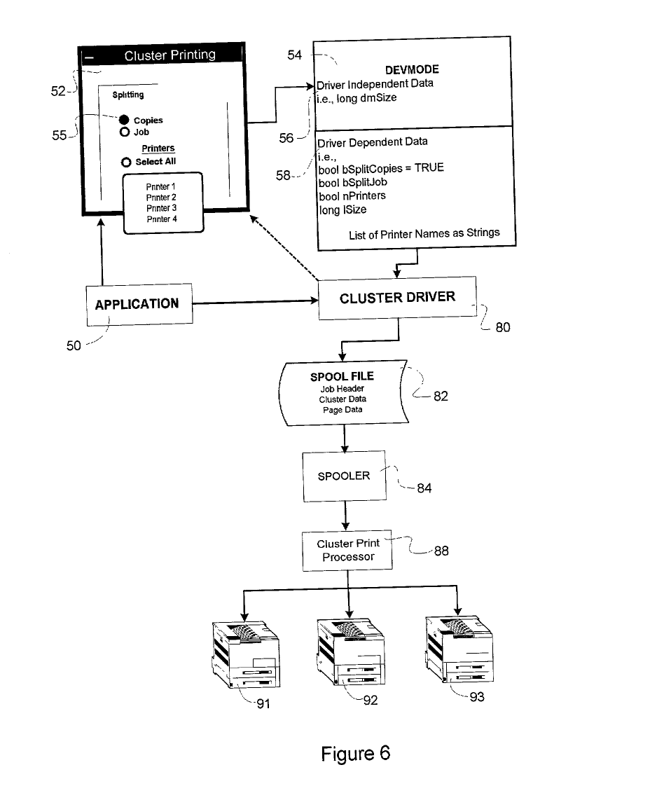

In reference to FIG. 6 another embodiment of the present invention may be illustrated. This particular embodiment is adapted for use with printer-ready files such as RAW format files and utilizes a driver-based cluster printing interface 52. In a typical use of this embodiment, an application or combination of applications 50 is used to create a print task. When the user is ready to print, the user will typically select a print option which begins the printing process and activates a print interface that prompts the user for print parameters. A user will be further prompted for cluster printing options with a cluster printing interface 52, such as a dialog box. This interface 52 will allow a user to select multiple printers and choose copy splitting and job splitting options as well as other cluster printing options. In this example, copy splitting 55 is selected to illustrate that function of this embodiment.

Once a user has made print dialog selections and cluster printing selections, device initialization and environment data 54 is sent to the cluster driver 80. In a Microsoft Windows operating system environment, device initialization and environment data 54 may be devmode data. Device initialization and environment data 54 may comprise driver independent data 56 and driver dependent data 58 as well as other data. Cluster driver 60 may also receive data directly from application 50 which may comprise print task data. After any required information is received, cluster driver 80 creates a spool file 82 which may comprise a print job header, cluster printing data, page data and/or other information. Spool file 82 is sent to spooler 84 for streaming to cluster print processor (CPP) 88.

Using the copy splitting example of this particular embodiment, CPP 88 will configure the print task according to selections made with cluster printing interface 52. In this example three printing devices have been selected so the print task is divided by sending copies of the print job to each selected printing device 91, 92 and 93. The same print job may be sent to each device simultaneously, particularly when an equal number of copies are sent to each printing device (91, 92 and 93). Alternatively, the print job may be sent to each printing device as many times as is needed to complete the copies desired.

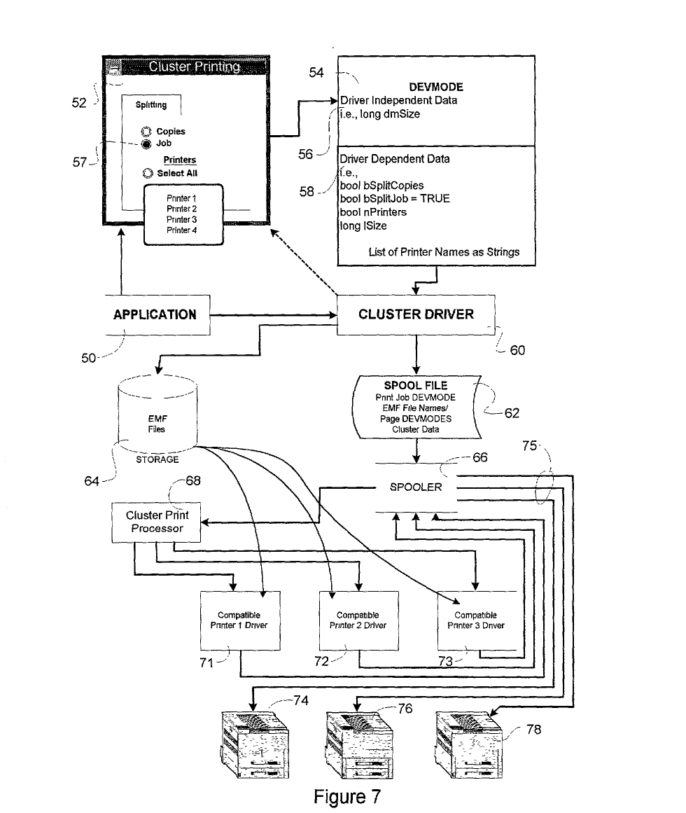

In reference to FIG. 7, a further embodiment of the present invention which effects a job splitting function and employs EMF files may be described. Application 50 may be a word processor, spreadsheet, database, graphics program or some other application or combination of applications as in previous embodiments. When a user is ready to print from the application 50, the user typically selects a print option from a menu structure or other selection which activates a print driver dialog box or other interface allowing the user to select from several print options. Cluster printing options may also be presented as a part of this dialog box, such as a tab within the box, as a separate dialog box 52 or as another form of interface. This interface 52 allows a user to select from several print task modification options. In some embodiments, cluster printing dialog box 52 may allow a user to select copy splitting and job splitting options as well as multiple printer selection. Other selections may also be available. In this particular embodiment, job splitting is selected to illustrate this function. It should be noted that these selections may be made in advance and default options may be selected to avoid repeated operations each time printing is performed.

Once a user has made print dialog selections and cluster printing selections, device initialization and environment data 54 is sent to the cluster driver 60. In a Microsoft Windows operating system environment, device initialization and environment data 54 may be devmode data. Device initialization and environment data 54 may comprise driver independent data 56 and driver dependent data 58 as well as other data. Cluster driver 60 may also receive data directly from application 50 which may comprise print task data.

Cluster driver 60 takes device initialization and environment data 54 and data from application 50 and creates a spool file 62 which may comprise print job data, EMF file identification data, page data, print task distribution data and other information. In systems which employ EMF files such as this example, Cluster driver 60 may also write EMF files 64 to storage for later access. Spool file 62 is sent to spooler 66 to continue the modified printing process. Spooler 66 performs typical spooler functions known in the art and sends print data to cluster print processor (CPP) 68.

CPP 68 takes data from spooler 66 and configures the print data for distribution to multiple printing devices. CPP 68 may modify the print task to achieve copy splitting, job splitting or other functions which distribute a print task among multiple printers, however, in this example, shown in FIG. 5, job splitting is selected 57. CPP 68 may split a task into multiple modified print tasks which are sent to the multiple compatible printer drivers 71, 72 or 73. In this embodiment, part of the data sent to printer drivers 71, 72 and 73 identifies the EMF files which correspond to a specific modified print task sent to an individual printer. With this data printer drivers 71, 72 and 73 may read the appropriate EMF files from storage 64 to complete a modified print task. In this example which illustrates a job splitting function, groups of pages of a print job are distributed among the selected printers. Generally, when printers have similar capacity and availability, an equal number of pages will be sent to each selected printer. However, when printer capabilities vary, more pages may be sent to one printer than another. Once a driver has all the data for a modified print task, the task is forwarded to a spooler 66 for spooling to a corresponding printer 74, 76 or 78. Typically, a modified print task comprising a portion of the original print task is sent to each selected printer 74, 76 and 78. In the case of job splitting, a range of pages is sent to each of the selected printers 74, 76 and 78. When printing device capabilities are similar, a similar number of pages may be sent to each device. For example, when a 300 page document is printed, 100 pages may be sent to each of the three selected devices thereby cutting printing time to one third of that required by a single printer.

The job splitting function illustrated in FIG. 7 requires that a different modified print task be sent to each printing device 74, 76 and 78 (each modified task will comprise a different range of pages). These different modified tasks are illustrated by separate arrows 75 in FIG. 7. When only copy splitting is selected, as illustrated in FIG. 5, the same print task is sent to each device as illustrated by a single arrow 65 in FIG. 5.

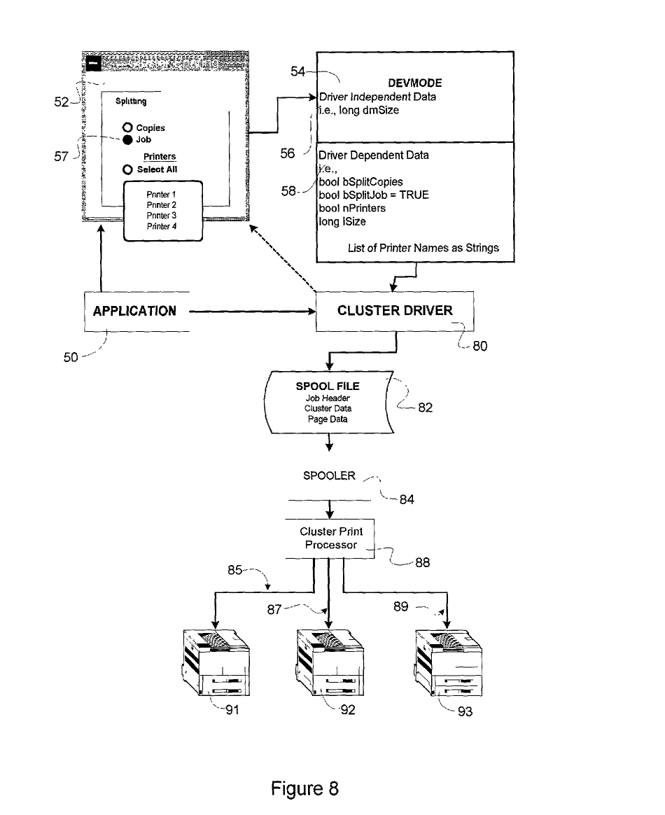

In another embodiment of the present invention, shown in FIG. 8, a job splitting function is illustrated with an embodiment which uses a printer-ready file format. This particular embodiment utilizes a driver-based cluster printing interface 52. In a typical use of this embodiment, an application or combination of applications 50 is used to create a print task. When the user is ready to print, she will typically select a print option which begins the printing process and activates a print interface that prompts the user for print parameters. A user will be further prompted for cluster printing options with a cluster printing interface 52, such as a dialog box. This interface 52 will allow a user to select multiple printers and choose copy splitting and job splitting options as well as other cluster printing options. In this example, job splitting 57 is selected to illustrate that function of this embodiment.

Print and cluster printing options may be selected at the time of printing through a conventional user interface such as interface 52 or may be pre-selected prior to the printing process and stored for later use. Once a user has made print dialog selections and cluster printing selections and initiated the printing process, device initialization and environment data 54 is sent to the cluster driver 80. In a Microsoft Windows operating system environment, device initialization and environment data 54 may be devmode data. Device initialization and environment data 54 may comprise driver independent data 56 and driver dependent data 58 as well as other data. Cluster driver 60 may also receive data directly from application 50 which may comprise print task data.

After any required information is received, cluster driver 80 creates a spool file 82 which may comprise a print job header, cluster printing data, page data and/or other information. Spool file 82 is sent to spooler 84 for streaming to cluster print processor (CPP) 88.

Using the job splitting example of this particular embodiment, CPP 88 will configure the print task according to selections made with cluster printing interface 52. In this example three printing devices have been selected so the print task is divided by sending portions of the print job to each selected printing device 91, 92 and 93. CPP 88 will split the print job into a number of portions 85, 87 and 89 equal to the number of printing devices selected. One portion 85, 87 or 89 will be sent to each of the printing devices. Each portion 85, 87 and 89 will comprise pages corresponding to a range of pages in the original print task. Portions may vary in size according to printer availability and capacity or other printing device parameters or the job may be split equally among the selected printing devices.

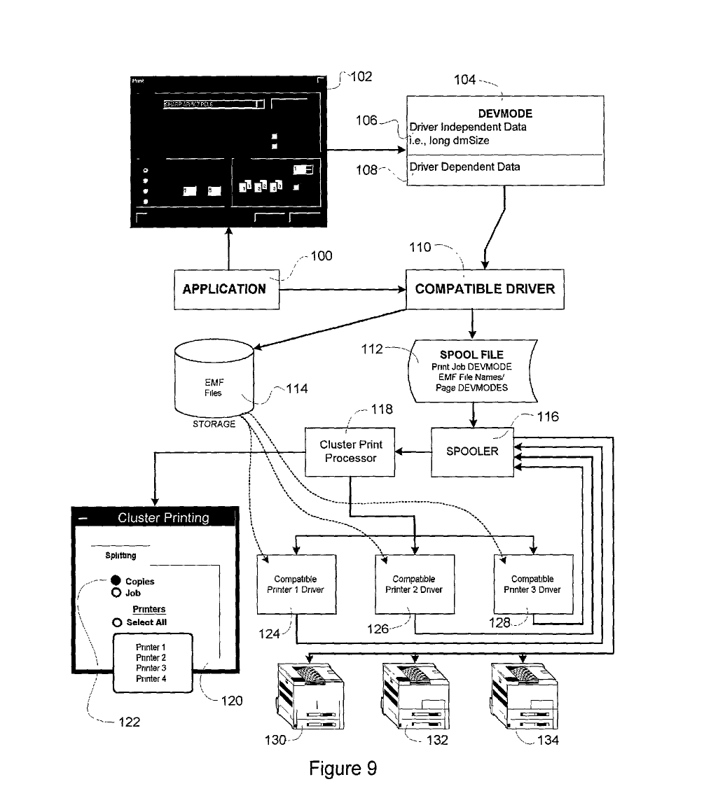

The embodiments of the present invention described above with reference to FIGS. 5-8 typically employ a driver-based user interface to obtain cluster printing data from a user. The embodiments described below with reference to FIGS. 9-12 typically employ a print-processor-based user interface to obtain cluster printing data from a user. These embodiments vary as to the origin of the user interface, however, optional features of one embodiment may be applied to others within the scope of the present invention.

A further embodiment of the present invention, illustrated in FIG. 9, comprises an application or combination of applications 100 which generates printable data. When a user desires to print data, the user typically selects a print option which activates a print dialog box 102 which allows a user to select from several printing options common in the art. Once a user has completed print option selections, device initialization and environment data 104 may be sent to a driver 110 which is compatible with other drivers in the cluster device group. Compatible driver 110 will also receive print data from application 100.

Driver 110 takes print task data from application 100 and device data 104 and creates a spool file 112 which may comprise print job data, EMF file identification data, page data and other information. Driver 110 may also write EMF files 114 to storage for later access by drivers 124, 126 and 128. These EMF files will typically be page specific data. Driver 110 sends spool file 112 to spooler 116 for streaming to cluster-enabled print processor (CPP) 118.

At some point in the printing process, CPP 118 will display a cluster printing interface 120 to prompt a user to select cluster printing options. These options may comprise copy splitting, job splitting, printing device selection and other options. In this embodiment, copy splitting is selected 122 to illustrate this function. Data received from cluster printing interface 120 is sent to CPP 118 and used to modify a print task so that it may be distributed to multiple printers. In this embodiment, three printers have been selected.

When a print task has been modified for copy splitting by CPP 118, the modified print task is sent to individual printer drivers 124, 126 and 128. With copy splitting, the same print task is sent to all printing devices, however, a different number of copies may be sent to each printing device according to device capacity, availability, user selection or other parameters. When a print task may be divided evenly among the selected printing devices and they have similar characteristics, each printing device 130, 132 or 134 and its corresponding driver 124, 126 or 128 will, generally, receive the same number of copies. Each printer driver 124, 126 and 128 receives modified print task data from CPP 118 and reads any EMF files 114 it may need from storage. This data is formatted for printing and sent to spooler 116 for spooling to printers 130, 132 or 134.

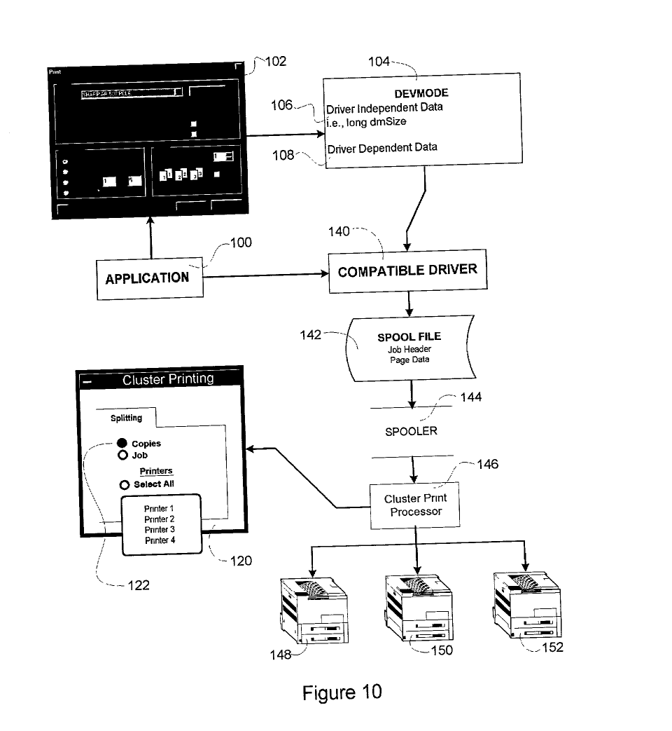

In reference to FIG. 10, yet another embodiment of the present invention may be illustrated. This particular embodiment is adapted for use with printer-ready files such as RAW format files and utilizes a print-processor-based cluster printing interface 120. In a typical use of this embodiment, an application or combination of applications 100 is used to create a print task. When the user is ready to print, she will typically select a print option which begins the printing process and activates a print interface 102 that prompts the user for print parameters. When these parameters have been provided, device initialization and environment data 104 is generated. Device data 104 may comprise driver independent data 106 and driver dependent data 108. In a Microsoft Windows environment, device data 104 may comprise devmode data. Device data 104 is transmitted to driver 140 for further processing. Print task data is also transmitted from application 100 to driver 140. Driver 140 combines this device data 104 and print task data from application 100 and creates a spool file 142. Spool file 142 may comprise job data, page data and other information. Spool file 142 is sent to spooler 144 for spooling to cluster-enabled print processor (CPP) 146.

Print task modification commands may be stored in a static configuration that is accessed by CPP 146. CPP 146 may also obtain print task modification commands from a user through the use of a user interface 120 such as a dialog box or similar prompting method. In this exemplary embodiment, copy splitting is selected 122 as a cluster printing option. Print-processor-based user interface 120 may comprise other prompts such as job splitting options, printing device selection and other options as described above for other embodiments. Once these option have been selected, CPP 146 may modify a print task so as to enable cluster printing options and distribute a print task among multiple printing devices. In this copy splitting example, the same print task is sent to multiple printers 148, 150 and 152 which may be directed to print multiple copies at each device. These copies may be distributed and proportioned in a variety of ways as described above for other embodiments.

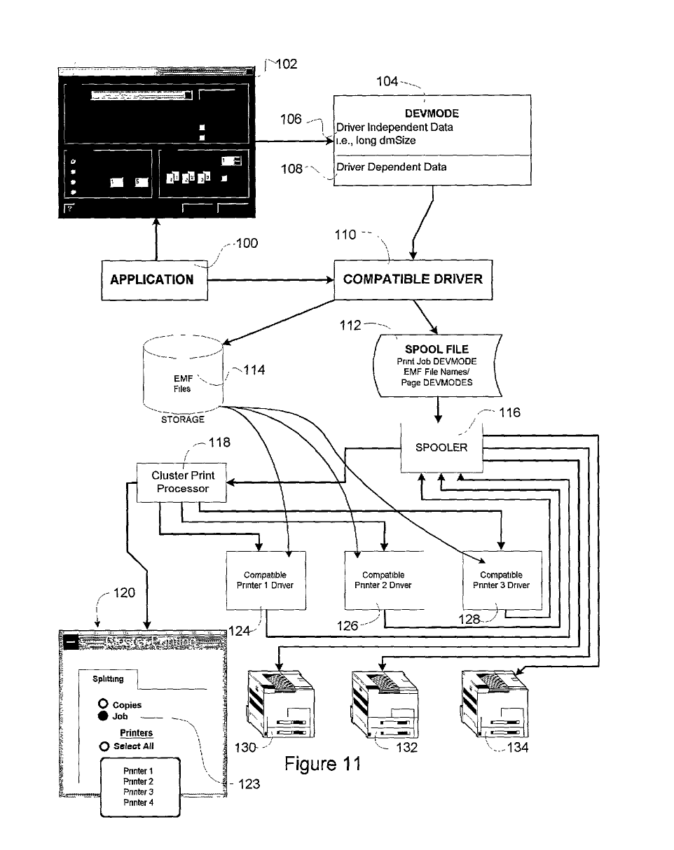

With reference to FIG. 11, a further embodiment of the present invention is described which comprises an application or combination of applications 100 which generates printable data. This particular embodiment may use journalled files such as EMF files. When a user desires to print data, the user typically selects a print option which activates a print dialog box 102 which allows a user to select from several printing options common in the art. Once a user has completed print option selections, device initialization and environment data 104 may be sent to a driver 110 which is compatible with other drivers in the cluster device group. Compatible driver 110 will also receive print data from application 100.

Driver 110 takes print task data from application 100 and device data 104 and creates a spool file 112 which may comprise print job data, EMF file identification data, page data and other information. Driver 110 may also write EMF files 114 to storage for later access by drivers 124, 126 and 128. These EMF files will typically be page specific data. Driver 110 sends spool file 112 to spooler 116 for streaming to cluster-enabled print processor (CPP) 118.

At some point in the printing process, CPP 118 will display a cluster printing interface 120 to prompt a user to select cluster printing options or access static configuration data. These options may comprise copy splitting, job splitting, printing device selection and other options. In this embodiment, job splitting is selected 123 to illustrate this function. Data received from cluster printing interface 120 is sent to CPP 118 and used to modify a print task so that it may be distributed to multiple printers. In this embodiment, three printers have been selected, however any number of printers may be selected for all embodiments of the present invention.

When a print task has been modified for job splitting by CPP 118, a print job is split into sub-components which generally comprise ranges of pages. These sub-components or modified print tasks are sent to individual printer drivers 124, 126 and 128. With job splitting, a different modified print task is sent to each printing device. The size of the modified print task sent to a printing device may vary according to device capacity, availability, user selection or other parameters. When a print task may be divided evenly among the selected printing devices and they have similar characteristics, each printing device 130, 132 or 134 and its corresponding driver 124, 126 or 128 will, generally, receive a modified print task with roughly the same number of pages. Each printer driver 124, 126 and 128 receives modified print task data from CPP 118 and reads any EMF files 114 it may need to render its modified task. This data is formatted for printing and sent to spooler 116 for spooling to printers 130, 132 or 134.

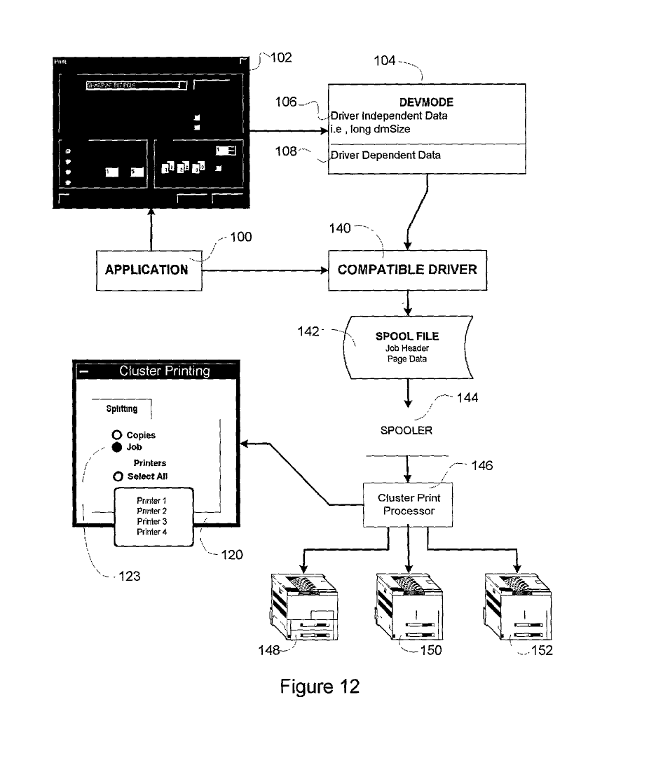

In reference to FIG. 12, another embodiment of the present invention may be illustrated. This particular embodiment is adapted for use with printer-ready files such as RAW format files and utilizes a print-processor-based cluster printing interface 120. In a typical use of this embodiment, an application or combination of applications 100 is used to create a print task. When the user is ready to print, the user will typically select a print option which begins the printing process and activates a print interface 102 that prompts the user for print parameters. When these parameters have been provided, device initialization and environment data 104 is generated. Device data 104 may comprise driver independent data 106 and driver dependent data 108. In a Microsoft Windows environment, device data 104 may comprise devmode data. Device data 104 is transmitted to driver 140 for further processing. Print task data is also transmitted from application 100 to driver 140. Driver 140 combines this device data 104 and print task data from application 100 and creates a spool file 142. Spool file 142 may comprise job data, page data and other information. Spool file 142 is sent to spooler 144 for spooling to cluster-enabled print processor (CPP) 146.

Print task modification commands may be stored in a static configuration that is accessed by CPP 146. CPP 146 may also obtain print task modification commands from a user through the use of a user interface 120 such as a dialog box or similar prompting method. In this exemplary embodiment, job splitting is selected 123 as a cluster printing option. Print-processor-based user interface 120 may comprise other prompts such as job splitting options, printing device selection and other options including those described above for other embodiments. Once these options have been selected and selection data is sent to CPP 146, CPP 146 may modify a print task so as to enable cluster printing options and distribute a print task among multiple printing devices. In this job splitting example, a different print task is sent to each of multiple printers 148, 150 and 152. The original print task is divided into portions represented by separate modified print tasks with each modified task being sent to a different printer. These printers may also be directed to print multiple copies of their respective modified print tasks. These modified print tasks and copies thereof may be distributed and proportioned in a variety of ways as described above for other embodiments

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for distributing a print task among multiple printers, said method comprising the acts of:
sending a print task to a print processor;
sending print task modification commands to said print processor; and
modifying said print task with said print processor.

2. The method of claim 1 wherein said sending said print task modification commands comprises reading command data from a configuration file.

3. The method of claim 1 further comprising the act of prompting a user for print task modification commands.

4. The method of claim 2 wherein said prompting is print-processor based.

5. The method of claim 2 wherein said prompting is driver-based.

6. The method of claim 1 wherein said modification comprises dividing said print task into multiple modified print tasks.

7. The method of claim 5 wherein said dividing comprises job splitting.

8. The method of claim 5 wherein said dividing comprises copy splitting.

9. The method of claim 5 wherein said dividing comprises a combination of copy splitting and job splitting.

10. The method of claim 1 wherein said modifying comprises dividing said print task into multiple modified print tasks and further comprising the act of distributing said multiple modified print tasks to a plurality of printing devices.

11. The method of claim 1 wherein said print task is a printer-ready file.

12. The method of claim 1 wherein said print task is journalled printer data.

13. A print processor capable of modifying a print task according to print task modification commands, said print processor comprising:
an input for receiving a print task;
an interface for receiving a print task modification command; and
an output for sending at least one modified print task.

14. The print processor of claim 11 wherein said interface receives print task modification commands independently of said input for receiving a print task.

15. The print processor of claim 11 wherein said interface is a dialog box.

16. The print processor of claim I1 wherein said interface prompts a user for job splitting parameters.

17. The print processor of claim II wherein said interface prompts a user for copy splitting parameters.

18. The print processor of claim I1 wherein said interface prompts a user for copy splitting and job splitting parameters.

19.The print processor of claim 11 wherein said interface prompts a user for multiple printer selection.

20. A computer readable medium comprising instructions for modifying a print task with a print processor, said instructions comprising the acts of:
sending a print task to a print processor;
sending print task modification commands to said print processor; and
modifying said print task with said print processor.

21. A computer data signal embodied in an electronic transmission, said signal having the function of modifying a print task with a print processor, said signal comprising instructions for:
sending a print task to a print processor;
sending print task modification commands to said print processor; and
modifying said print task with said print processor.

22. A method for modifying a print task with a print processor, said method comprising the acts of:
sending a print task to a driver;
prompting a user for print task modification commands;
creating a spool file for said print task;
sending said spool file to a spooler;
spooling said spool file to a modifying print processor;
modifying said print task according to said print task modification commands thereby creating at least one modified print task;
sending said at least one modified print task to at least one printing device.

23. A method for distributing a print task to multiple printing devices with a print processor, said method comprising the acts of:
generating a print task from an application, said print task being configured for printing on a single printing device;
invoking a print driver for combining device initialization and environment data for said single printing device and print task data from said application and creating a spool file;
obtaining cluster printing data;
sending said spool file to a spooler;
spooling said spool file to a cluster-enabled print processor (CPP);
modifying said spool file data with said CPP to cause said print task to be distributed to multiple printing devices thereby creating at least one modified print task; and
sending said at least one modified print task to said multiple printing devices.
